(19) United States
(12) Patent Application Publication
(10) Pub. No.: US 2014/0211484 A1
(43) Pub. Date: Jul. 31, 2014

(54) LIGHT MODIFYING ELEMENTS

(71) Applicant: Leslie David Howe, Atlanta, GA (US)

(72) Inventor: Leslie David Howe, Atlanta, GA (US)

(73) Assignee: Southpac Trust International Inc, Trustee of the LDH Trust, Rarotonga (CK)

(21) Appl. No.: 14/231,819

(22) Filed: Apr. 1, 2014

Related U.S. Application Data
(63) Continuation of application No. PCT/US2013/059919, filed on Sep. 16, 2013.
Application No. PCT/US2013/059919 is a continuation of application No. PCT/US2013/039895, filed on May 7, 2013.
(60) Provisional application No. 61/958,559, filed on Jul. 30, 2013.
(60) Provisional application No. 61/959,641, filed on Aug. 27, 2013.
(60) Provisional application No. 61/848,526, filed on Jan. 7, 2013.
(60) Provisional application No. 61/795,420, filed on Oct. 17, 2012.
(60) Provisional application No. 61/742,251, filed on Aug. 6, 2012.
(60) Provisional application No. 61/741,669, filed on Jul. 26, 2012.

(51) Int. Cl. F21V 11/00; F21V 13/02; F21V 5/04

(52) U.S. Cl. CPC F21V 11/00; F21V 5/04; F21V 13/02
USPC 362/326; 362/351

(57) ABSTRACT

Example embodiments of the disclosed technology include systems, methods, and/or apparatus for modifying light. In example implementations, a light modifying element or assembly of light modifying elements is provided and is configured to modify light from a light source. The light modifying elements can include various configurations and assemblies disclosed herein, which may comprise V-shaped, curved, or truncated-pyramid shaped light modifying elements, wherein one or more optical film pieces are characterized by one or more edge trusses disposed at two or more opposing edges of at least one of the one or more optical film pieces. The one or more edge trusses are characterized by one or more folds of at least a portion of at least one of the one or more optical film pieces. Edge trusses are further characterized to support two or more opposing optical film edges in a substantially planar configuration.

### RELATED APPLICATIONS

This application claims the benefit under 35 U.S.C. 365 of PCT Patent Application No. PCT/US2013/059919 entitled “Light Modifying Elements,” filed Sep. 16, 2013, the contents of which are incorporated by reference in their entirety as if set forth in full. This application also claims the benefit under 35 U.S.C. 365 of PCT Patent Application No. PCT/US2013/039895 entitled “Frameless Light Modifying Element,” filed May 7, 2013, the contents of which are incorporated by reference in their entirety as if set forth in full. PCT application PCT/US2013/039895 claims the benefit of the following United States provisional patent applications, the contents of which are incorporated herein by reference in their entirety, as if set forth in full: U.S. provisional application No. 61/741,669 entitled “Frameless Optical Film Lens” filed Jul. 26, 2012; U.S. provisional application No. 61/742,251 entitled “Frameless Optical Film Lens” filed Aug. 6, 2012; U.S. provisional application No. 61/795,420 entitled “Frameless Optical Film Lens” filed Oct. 17, 2012; and U.S. provisional application No. 61/848,526 entitled “Frameless Optical Film Lens” filed Jan. 7, 2013. This application also claims priority to the following U.S. Provisional Patent Applications, the contents of which are incorporated by reference in their entirety as if set forth in full: U.S. provisional patent application No. 61/958,559 entitled “Hollow Truncated-Pyramid Shaped Light Modifying Element,” filed Jul. 30, 2013; and U.S. provisional patent application 61/959,641, entitled “Light Modifying Elements,” filed Aug. 27, 2013. This application also claims priority to U.S. Non-provisional patent application Ser. No. 14/225,546, entitled “Frameless Light Modifying Element,” filed Mar. 26, 2014, the contents of which are incorporated by reference in their entirety as if set forth in full.

### TECHNICAL FIELD

This invention generally relates to lighting, light fixtures and lenses.

### BACKGROUND

Lighting fixtures, whether designed for commercial or residential applications may typically utilize lens systems to control the fixture's light distribution pattern, light intensity and diffusion. There is a continuing long felt need for lens systems that can provide the required control of a light fixture's output, but do so with improved cost effectiveness, efficiency and aesthetics.

### BRIEF SUMMARY

Certain example embodiments of the disclosed technology may include systems, methods, elements and/or apparatus for modifying light.

According to an implementation of the disclosed technology, a biplanar light modifying element is configured to modify light from a light source wherein the light source is disposed in proximity to an inner portion of the biplanar light modifying element. The biplanar light modifying element comprises one or more optical film pieces characterized by one or more edge trusses disposed at two or more opposing edges of at least one of the one or more optical film pieces. The one or more edge trusses are characterized by one or more folds of at least a portion of at least one of the one or more optical film pieces. The one or more edge trusses disposed at two or more opposing edges are further characterized to support the one or more edge trusses on the two or more opposing edges in a substantially planar configuration. The biplane light modifying element is further configured with at least one fold in a central area of the one or more optical film pieces, wherein the one fold is substantially parallel to one or more edge trusses.

According to an implementation of the disclosed technology, a biplanar light modifying element is configured to modify light from a light source located in proximity to an inner portion of the biplanar light modifying element. The biplanar light modifying element comprises at least two planar lens members configured in an elongated V-shape. The at least two planar lens members are characterized by an optical material that includes one or more of:
a) embedded diffusion particles configured to scatter the light from the light source
b) at least one surface characterized by a plurality of surface features arranged in a random distribution pattern and configured to scatter light from the light source.

According to an implementation of the disclosed technology, a curved light modifying element is provided and configured to modify light from a light source located in proximity to an inner portion of the curved light modifying element. The curved light modifying element comprises one or more optical film pieces characterized by a central light emitting portion and one or more edge trusses disposed at two opposing edges of at least one of the one or more optical film pieces. The one or more edge trusses are characterized by one or more folds of at least a portion of at least one of the one or more optical film pieces. The one or more edge trusses disposed at two opposing edges are further characterized to support the two opposing edges of the one or more optical films in a substantially planar configuration. The central light emitting portion is configured into a curved shape by laterally moving the two opposing edges of the one or more optical films towards each other.

According to an implementation of the disclosed technology, a light modifying element is provided which comprises one or more optical film pieces characterized by one or more edge trusses disposed on each edge of at least one of the one or more optical film pieces. The one or more edge trusses are characterized by one or more folds of at least a portion of at least one of the one or more optical film pieces. Edge trusses disposed at each edge are further characterized to support the one or more optical film pieces in a substantially planar configuration. The one or more optical film pieces are further configured to form a hollow truncated pyramid shape characterized by four sloping sides, a planar base and a planar top wherein the plane of the planar top is substantially parallel to the plane of the planar base, and wherein the perimeter of the planar top is smaller than the perimeter of the planar base.

According to an implementation of the disclosed technology, an assembly of light modifying elements is configured to modify light from a light source, and comprises two or more light modifying element sections. Each section is characterized by one or more optical film pieces, wherein one or more edge trusses are configured on two or more opposing sides of at least one of the one or more optical film pieces. The one or more edge trusses are characterized by one or more folds of at least a portion of at least one of the one or more optical film pieces. The one or more edge trusses are further characterized to support at least two or more edges of the one or more optical film pieces in a substantially planar configuration.

Other embodiments, features, and aspects of the disclosed technology are described herein and are considered a part of the claimed technology. Other embodiments, features, and aspects can be understood with reference to the following detailed description, accompanying drawings, and claims.

### BRIEF DESCRIPTION OF THE FIGURES

FIG. 1 depicts a cross-sectional view of an example embodiment of biplanar light modifying element.

FIG. 2 depicts prior art.

FIG. 3A depicts a top perspective view of an example embodiment of biplanar light modifying element.

FIG. 3B depicts a bottom perspective view of an example embodiment of biplanar light modifying element.

FIG. 4 depicts a diagram of light ray propagation from a light source disposed inside an example embodiment of biplanar light modifying element.

FIG. 5A shows an example polar graph of an LED array photometric pattern.

FIG. 5B shows a polar graph of light dispersion photometric pattern of an example embodiment of biplanar light modifying element.

FIG. 5C shows a polar diagram of a batwing light distribution photometric pattern.

FIG. 6A shows a perspective view of an example embodiment of biplanar light modifying elements attached to a recessed light fixture.

FIG. 6B shows an exploded perspective view of the example embodiment of biplanar light modifying elements attached to a recessed light fixture as depicted in FIG. 6A.

FIG. 7A shows a perspective view of an example embodiment of a biplanar light modifying element comprising optical film.

FIG. 7B shows a cross-sectional view of the example embodiment of a biplanar light modifying element comprising optical film as depicted in FIG. 7A.

FIG. 8A depicts a perspective view of a recessed light fixture with example embodiments of optical film biplanar light modifying elements mounted to the light fixture.

FIG. 8B shows an exploded view of FIG. 8A.

FIG. 8C shows a cross-sectional cut-away view of the light fixture and example embodiments of biplanar light modifying elements depicted in FIG. 8B.

FIG. 9A shows a perspective view of an example embodiment of biplanar light modifying element comprising two layers of optical film.

FIG. 9B shows a perspective view of the biplanar light modifying element depicted in FIG. 9A, with the inner layer of optical film partially removed from the example embodiment.

FIG. 9C depicts an optical film cutting and scoring template for the example embodiment of biplanar light modifying element depicted in FIG. 7A and FIG. 7B.

FIG. 10 depicts a light ray propagation diagram of an example embodiment of biplanar light modifying element comprising light condensing optical film.

FIG. 11 depicts a polar graph of an example light dispersion photometric pattern from an example embodiment of biplanar light modifying element comprising light condensing optical film.

FIG. 12A depicts a perspective rear view of an example embodiment of a hollow truncated-pyramid shaped light modifying element.

FIG. 12B depicts a perspective front view of an example embodiment of a hollow truncated-pyramid shaped light modifying element.

FIG. 12C depicts a front plan view of an example embodiment of a hollow truncated-pyramid shaped light modifying element.

FIG. 13A depicts a perspective front view of an example embodiment of a hollow truncated-pyramid shaped light modifying element mounted on a luminaire.

FIG. 13B depicts an exploded front perspective view the of the example embodiment as depicted in FIG. 13A.

FIG. 14 depicts a perspective front view of an example embodiment of a hollow truncated-pyramid shaped light modifying element mounted on a luminaire wherein the light modifying element is oriented 180 degrees opposite to that of the light modifying element depicted in FIG. 13A.

FIG. 15 depicts an optical film cutting and scoring template to fabricate an example embodiment of a hollow truncated-pyramid shaped light modifying element configured from optical film.

FIG. 16A depicts a front perspective view of an example embodiment of a hollow truncated-pyramid shaped light modifying element configured from the cutting and scoring template depicted in FIG. 15.

FIG. 16B depicts a rear perspective view of the example embodiment of a hollow truncated-pyramid shaped light modifying element depicted in FIG. 16A.

FIG. 17A depicts a perspective view of an example embodiment of light modifying element comprising a curved shape.

FIG. 17B depicts a cross-sectional view of the example embodiment of the curved light modifying element shown in FIG. 17A.

FIG. 18A depicts a recessed light fixture with example embodiments of curved optical film light modifying elements mounted to the light fixture.

FIG. 18B shows an exploded view of the recessed light fixture as shown in FIG. 18A.

FIG. 18C shows a cross-sectional cut-away view of the light fixture and example embodiments of curved optical film light modifying elements as depicted in FIG. 18B.

FIG. 19 depicts an optical film cutting template for the example embodiments depicted in FIGS. 18A, 18B, and 18C.

FIG. 20A shows a rear perspective view of an example embodiment of a light modifying element.

FIG. 20B shows a front perspective view of an example embodiment of a light modifying element.

FIG. 20C shows a perspective exploded rear view of an example embodiment of a light modifying element.

FIG. 21A shows a flat optical film cutting and scoring template, according to an example implementation of the disclosed technology.

FIG. 21B shows a flat optical film cutting and scoring template, according to an example implementation of the disclosed technology.

### DETAILED DESCRIPTION

Embodiments will be described more fully hereinafter with reference to the accompanying drawings, in which example embodiments are shown. The disclosed technology may, however, be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

It should be clearly understood that the embodiments described herein are examples, and may be adapted for use with many different designs and configurations including, but not limited to: different dimensions, different optical film configurations, different mounting configurations, different fabrication materials, different light fixture enclosures etc.

Various methods, concepts, designs, and parts may be combined to produce desired operating specifications for light fixture lenses or film assemblies according to example embodiments, and will be described with reference to the accompanying figures.

For brevity, elements, principals, methods, materials or details in example embodiments that are similar to, or correspond to elements, principals, methods, material or details elsewhere in other example embodiments in this application, or related applications, may or may not be repeated in whole or in part, and should be deemed to be hereby included in the applicable example embodiment.

US Patent Application US2011/0044061 A1 to Santoro et al., teaches “This disclosure enables construction of kinoform diffusers that exhibit controllable diffusion characteristics with off-axis transmittance and reflectance properties, elimination of zero-order beam, and freedom from spectral dispersion under achromatic illumination. Kinoform diffusers made in accordance with the disclosure embody surface relief patterns that produce specific beam distributions. These patterns are embodied in physical kinoform diffusers using known photographic techniques and replication technologies. The disclosed embodiments enable physically realizable specific beam distributions other than beam distributions characterized by a negative exponential or substantially Gaussian function.”

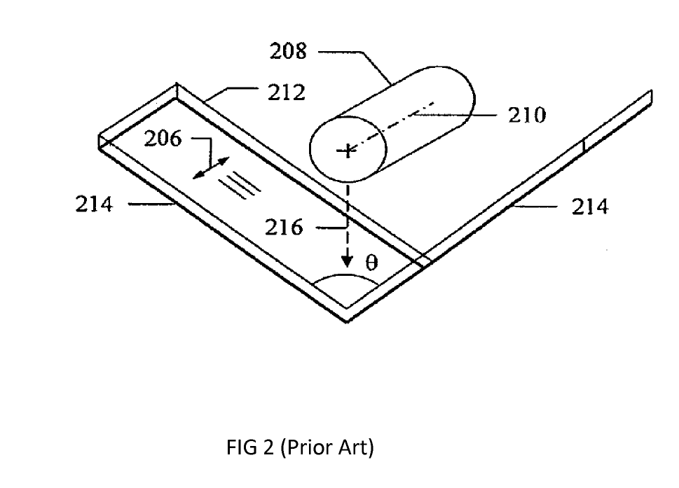

Referring to FIG. 2 (prior art), Santoro et al. further teach “In a ninth preferred embodiment (FIG. 25A), an outwardly folded transparent substrate 212 formed of two generally planar portions arranged in a V-shape is positioned below a linear light source 208 having a major axis 210, with linear or elliptical distribution kinoform diffuser portions 214 applied to either side of substrate 212. (Kinoform diffuser portions 214 are shown on the side facing toward light source 208 for the purposes of illustration.) Kinoform diffuser portions 214 are oriented such that their planes of diffusion 206 are parallel to major axis 210 of light source 208.”

For some commercial and residential lighting applications, the kinoform diffusers described by Santoro et al. may not be cost effective due to more complex manufacturing methods and higher manufacturing costs compared to other types of diffusers. Some optical properties of kinoform diffusers comprising a V-shape as taught by Santoro et al such as a “batwing” light distribution pattern may be achieved by utilizing embodiments of the disclosed technology of this application, along with other advantages which may include significantly lower manufacturing costs.

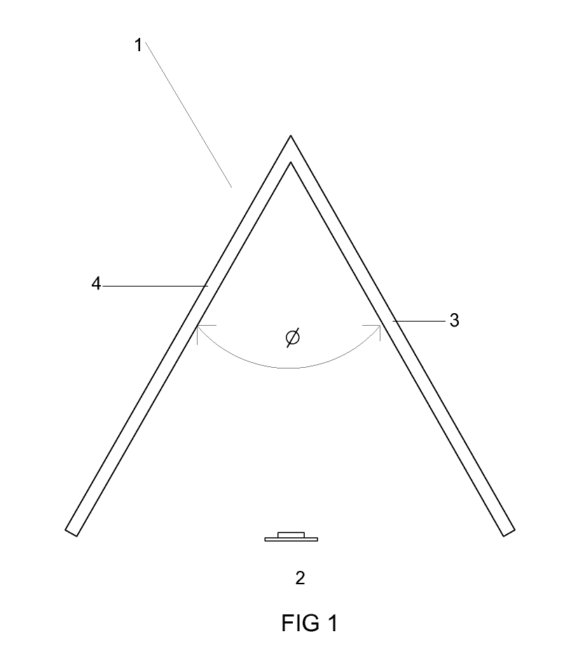

FIG. 1 depicts a side profile view of an example implementation of the disclosed technology. Light modifying element (LME) 1 may include two intersecting lens members 3, 4, which may comprise a clear or translucent substrate configured to modify light from a light source 2 that may be disposed in proximity to the base of inner portion of the two intersecting lens members 3, 4. The substrate may include any type of substrate that may provide suitable structure and optical properties for the intended application. Examples of suitable substrates may include polycarbonates, acrylics, optical film etc. The substrate may have associated with it any type of light modifying features that may be suitable for an intended application. In one example implementation, the substrate may have a light modifying layer deposited on either or both surfaces. For example, in one embodiment, the light modifying layer(s) may include diffusion particles such as glass beads. In other example implementations, the substrate may have light modifying elements incorporated within the substrate itself, such as diffusion particles for example. In certain example implementations, the substrate may have features formed onto its outer surface, such as prismatic features. In accordance with various example implementations of the disclosed technology, the substrate may have various combinations of light modifying features, for example, particles incorporated into the substrate itself and a light modifying layer deposited on one or more surfaces.

In an example implementation, the light source 2 may include any light source including but not limited to LEDs, fluorescent tubes. Although a linear light source may have advantages in many configurations and applications, the light source may comprise any other form, such as standard light bulbs, self-ballasted CFLs or any configuration or arrangements of LEDs. In certain embodiments, the intersection angle Φ between the lens members 3, 4 may be varied to affect the light distribution properties of the LME 1

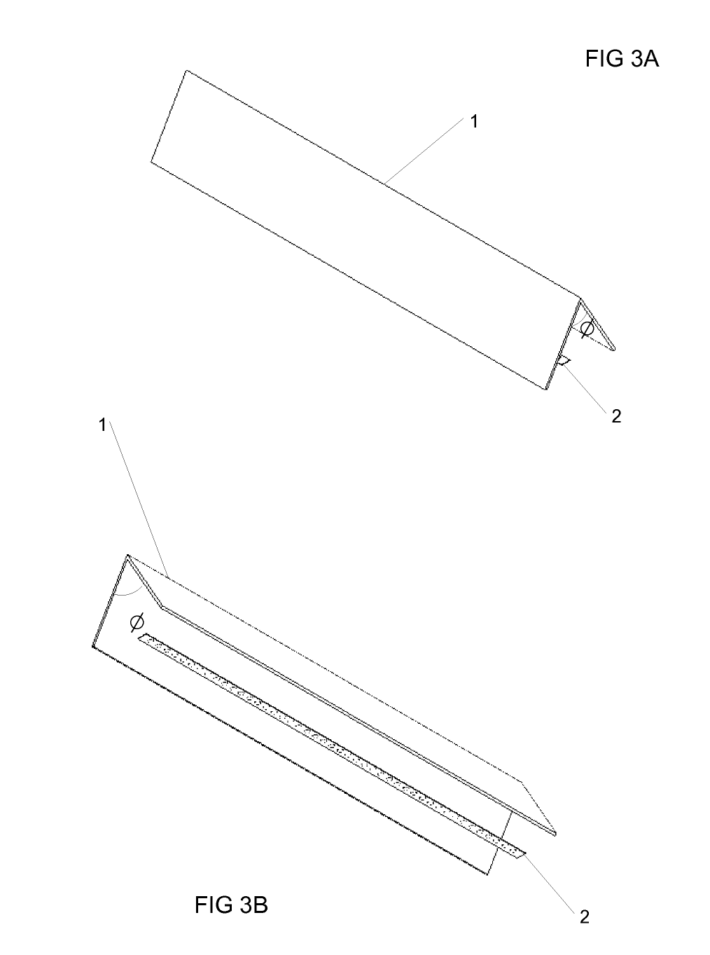

An example embodiment is shown in FIG. 3A that depicts a top perspective view, and in FIG. 3B that depicts a bottom perspective view of the LME 1. According to an example implementation, the LME 1 may be configured from typical traditional, cost effective diffuser materials used in commercial and residential lighting fixtures, which may for example, may comprise a rigid transparent substrate such as acrylic or polycarbonate, and then formed into a diffuser lens with an elongated V-shaped cross section. In certain example implementations, any acceptable manufacturing method such as injection molding, extrusion, etc. may be utilized for producing the components of the LME 1. According to an example implementation of the disclosed technology, the substrate of the LME 1 may have diffusion particles dispersed within the resin itself prior to forming the LME 1. In another example implementation, the substrate may have a layer containing diffusion particles deposited on any of its surfaces. As depicted in FIG. 3A, the intersection angle Φ between the planes formed by the two lens members 3, 4 is shown, along with a light source 2 that may be disposed inside the LME 1 near the base of the V-shaped structure.

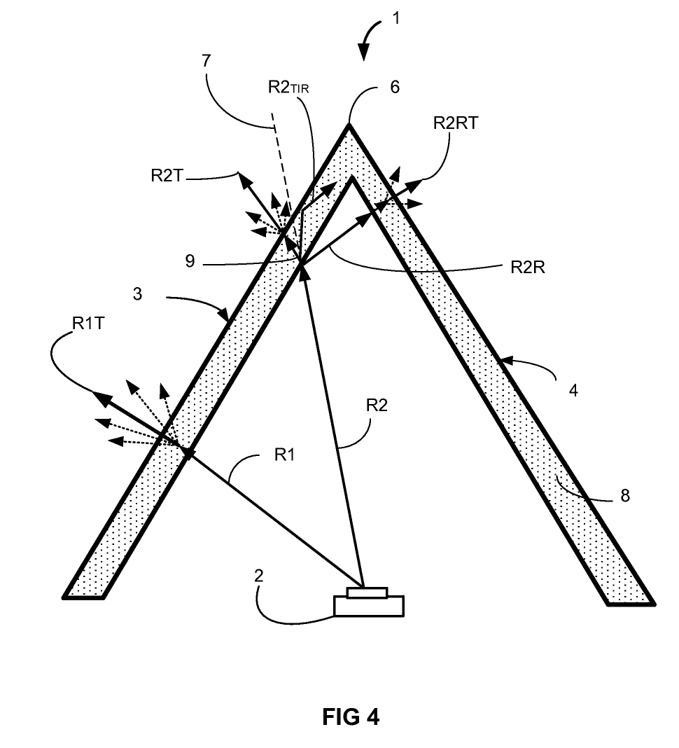

FIG. 4 depicts an end-view or cross sectional diagram (not to scale) of example embodiments of the LME 1 as depicted in FIG. 3A and 3B. As described above, the LME 1 may comprise lens members 3, 4 arranged having the acute angle (for example, the intersection angle Φ as shown in FIG. 1) of the lens members 3, 4 opening towards the light source 2. As shown in each of the figures, and according to certain example embodiments, a relative orientation of the light source 2 with respect to the lens members 3, 4 may be may be “fixed,” but the entire LME 1 structure (including the light source 2) may be configured such that the majority of the light travels in an “upwards” direction (as indicated in FIG. 4). It should be readily understood that in other example embodiments, the entire the LME 1 structure (including the light source 2) may be rotated, mounted, etc., such that the majority of the light travels in any desired direction. For example, in one embodiment, the LME 1 (as shown in FIG. 4) may be rotated 180 degrees so that the light source 2 is disposed above the lens members 3, 4 with the light emitting in a downwards direction (not shown).

In certain example implementations, the lens members 3, 4 may comprise an acrylic substrate with diffusion particles 8 suspended within the substrate (as indicated by the dot hatch pattern in the lens members 3, 4). FIG. 4 depicts an example first light ray R1 originating from the light source 2, traveling through a first lens member 3, and scattering into a first scattering transmission group R1T. In this depiction, the ray R1 is shown incident approximately normal to the surface of the first lens member 3. Thus the interaction of the incident ray R1 with the diffusion particles 8 may result in incident light ray R1 scattering in a diffusion pattern (depicted by the small group of arrows exiting the lens member 3) about the approximate normal of the lens member 3.

A second light ray R2 is depicted in FIG. 4 to illustrate some of the factors that may influence the photometric pattern resulting from the modification of the light transmission direction when the incident light travels from the light source 2 to the LME1 in a direction closer to that of the apex 6 of the LME 1. The second light ray R2 is shown traveling in an approximate path 7 from the light source 2 to the first lens member 3 such that the incidence angle is acute with respect to the plane parallel to the surface of the lens member 3. In this example embodiment, a portion of the second incident light ray R2 may reflect from the first surface of the lens member 3. The resulting reflected ray R2R may traverse to and through the second lens member 4, interact with the diffusion particles 8, and scatter in a diffusion pattern, as indicated by the transmitted diffusion pattern R2RT approximately normal to the second lens member 4. According to certain example implementations of the disclosed technology, various factors may be utilized to control the photometric pattern produced by the LME 1. Such factors may include, but are not limited to: the intersection angle Φ angle between the lens members 3, 4, polarization of the incident light, material, size and density of the diffusion particles 8, surface features, refractive index of the lens members 3, 4, etc. For example, an increase or a decrease the percentage of light reflected and transmitted at the various surfaces may be controlled by the intersection angle Φ angle between the lens members 3, 4, and/or the polarization of the light from the light source 2.

In an example implementation, the portion 9 of the second incident light ray R2 (that is not part of the reflected ray R2R) may traverse the bulk of first lens member 3 and undergo scattering due to interaction with the diffusion particles 8. In an example implementation, a certain portion of the scattered light may undergo total internal reflection within the lens member 3 if the scattered light portion's angle with respect to the normal of the first lens member exceeds the critical angle. Thus, the light portion RT_{TIR} undergoing total internal reflection may not contribute to the transmitted portion (i.e., the second scattering transmission group R2T) of the light exiting the lens member 3 (that originated from the second incident light ray R2). Thus, in certain example implementations, the transmission light intensity for rays directed towards the apex 6 (for example, the second scattering transmission group R2T) may: (a) experience a reduction in intensity compared to the transmitted light for the for rays directed towards the normal of the lens members 3, 4 (for example, compared to the first scattering transmission group R1T; and (b) the scattering transmission group general direction (for example the direction of the second scattering transmission group R2T) may be altered to transmit in a direction towards the normal of the exit surface, rather than following the approximate direction of the path 7 from the light source 2, as would be the case without diffusion particles 8.

According to certain example embodiments, other factors may influence the photometric pattern. For example, due to the angle of incidence of ray R2 on lens member 3, the distance traveled within the lens member 3 by the transmitted portion 9 may be greater than the distance for a similar portion derived from normal incidence (for example, from light ray r1), and may cause result in increased scattering, refraction, reflection and/or absorption.

According to an example implementation of the disclosed technology, a cumulative result of the interaction of light with the LME 1, as described above may be that a portion of light from light source 2 traveling in a direction towards the apex 6 may undergo additional increased scattering and subsequent reflection, refraction and absorption than the light rays striking the lower portion of the LME 1 and normal to the plane of lens members 3, 4. In certain embodiments, the scattering and/or total internal reflection of the light from light source 2 may be highest near the apex 6 and may decrease in a linear fashion towards the normal of lens members 3, 4. Accordingly, the LME 1 may have the effect of decreasing transmitted relative light levels that exit lens members 3, 4 as the incident light rays are directed towards the apex 6.

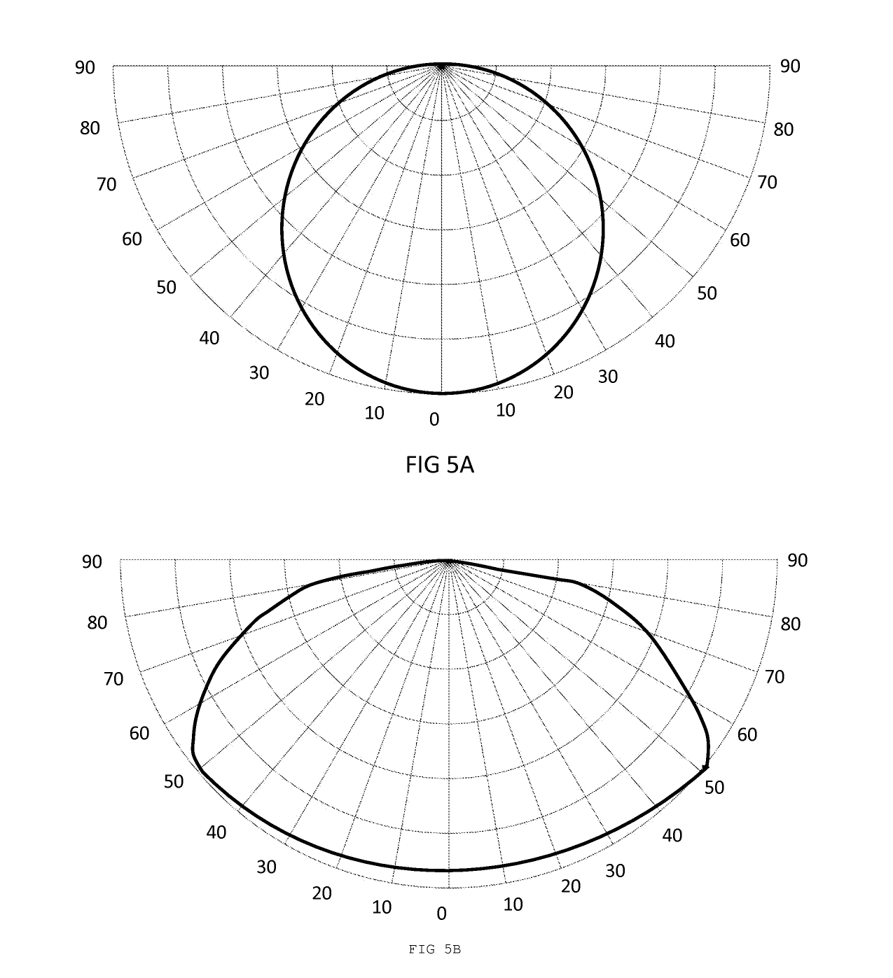

We now will discuss various light sources, as contemplated and tested in accordance with certain example embodiments of the disclosed technology. In one example implementation, a light emitting diode (LED) strip may be utilized as the light source 2. In one example implementation, the LED strip may be use without any lens. In such an embodiment, the LED strip may exhibit a half brightness-viewing angle of approximately 120 degrees along the longitudinal axis of the LED strip, with maximum light intensity occurring at the nadir. An approximated polar graph of the light distribution may look similar to that shown in FIG. 5A.

FIG. 5B shows a theoretical approximated polar graph of the same LED strip light source 2 disposed inside an example embodiment of LME 1 shown in FIG. 3A, 3B and FIG. 4. In one example implementation, the LME 1 may have the effect of decreasing transmitted relative light levels exiting lens members 3, 4 in a linear fashion from 90 degrees towards 0 degrees as described above. This relative inverse relationship may have the net effect of keeping the light intensity relatively constant over a wide viewing angle as shown in FIG. 5B. In comparison, a LED strip without the benefit of an LME 1 (as described herein) may have a maximum light output at 0 degrees with decreasing light levels towards 90 degrees as shown in FIG. 5A.

In certain example implementations, the wide distribution angle of the transmitted light, as a result of interaction with the lens members (as in lens members 3, 4 of FIG. 4) as described may be advantageous in many lighting applications. A wide distribution pattern may allow fixtures to be spaced further apart, which may allow a lower number of fixtures to be used in a given space.

Another advantage provided by example embodiments of the disclosed technology may include lamp hiding. For example, a problem may exist with LEDs in general wherein the extremely high brightness point source nature of LEDs may require relatively large amounts of diffusion in order to soften and blend (“lamp hiding”) the point sources in order to create a visually acceptable appearance. As described in FIG. 4, an example embodiment of the LME 1 may present the highest level of diffusion (and therefore lamp hiding) to the light source 2 at 0 degrees, where light intensity of LED strip 2 may be highest. As the level of diffusion, attenuation, and/or scattering imparted on the incident light decreases for light rays as they move away from the apex of the LME 1, the relative apparent transmitted light levels may correspondingly decrease towards the apex. The net result may be that a visually acceptable level of lamp hiding may be present throughout the viewing area. This may allow lens material with lower relative diffusion levels to be utilized to accomplish a given degree of lamp hiding when compared to flat or curved lenses. This may also increase overall luminaire efficiency in some applications.

The wide light distribution pattern as shown in FIG. 5B, and produced by an example embodiment of LME 1, may have an increased light intensity in the 75 to 90 degree zones, which in certain embodiments may cause increased high angle glare in ceiling mounted lighting applications. However, most recessed style light fixtures may have their lamps recessed relative the light fixture face, which may provide a hard visual cutoff of light dispersion in the high angle glare zones.

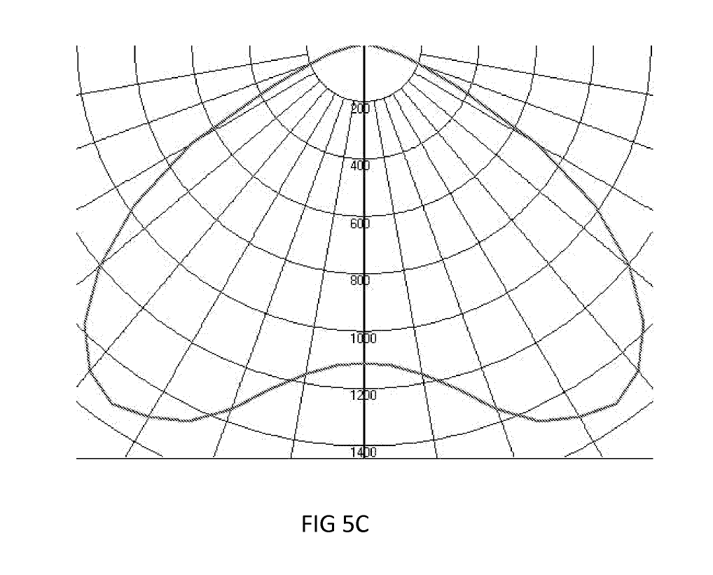

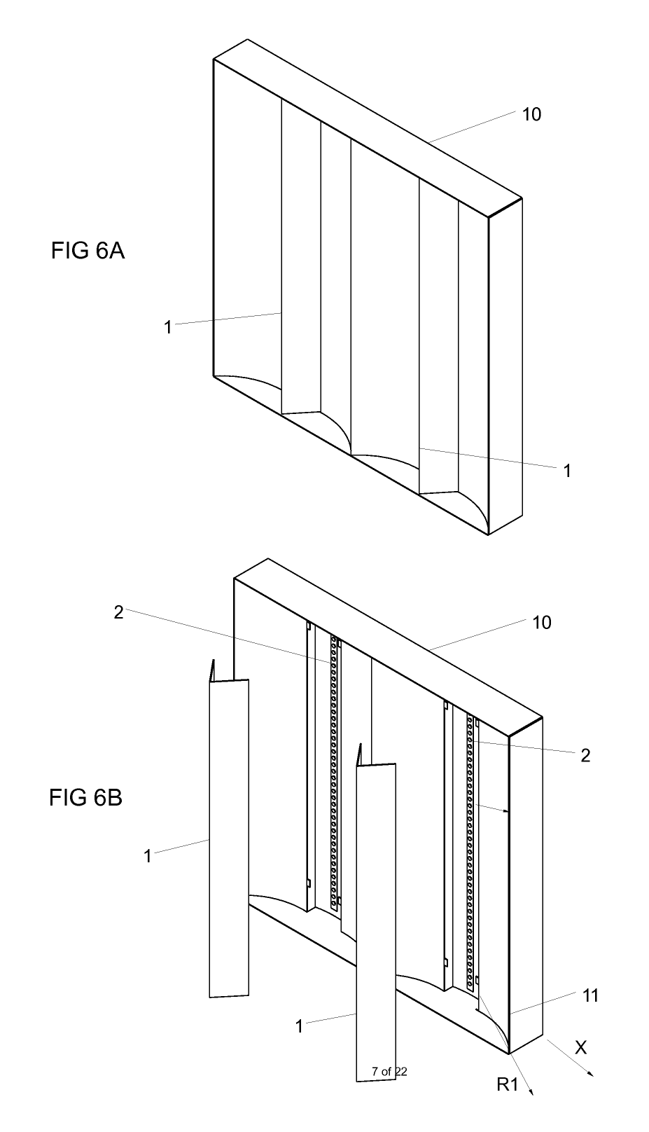

FIG. 6A shows an example perspective view of a recessed lighting fixture 10 with two LME's 1 (without mounting features shown). FIG. 6B shows an exploded view of the same, depicting two LED strip light sources 2. In FIG. 6B, arrow X shows the direction of the member of the back of the light fixture 10 on which the LED strips 2 may be disposed. An example light ray R1 originating from the LED strip 2 may just clear light fixture edge 11. Thus, in one embodiment, light rays from light source 2 between X and R1 may therefore be shielded from direct view. This embodiment may provide a relatively good reduction in high angle glare.

As previously described, the light modifying characteristics of example embodiments LME 1 may be altered by varying the intersection angle Φ of lens members 3, 4. Referring again to FIG. 4, as the intersection angle Φ is decreased, the overall level of light scattering may be increased due to an overall increase in the light striking the lens members 3, 4 at an angle of incidence away from the normal to the plane surface of the lens members 3, 4 and a wider light distribution pattern may also result. Depending on the overall diffusion level of the LME substrate and the intersection angle Φ, light levels in the approximate 0-25 degree zones may decrease relative to the 25-60 degree zones, which may create a degree of desirable “batwing” light distribution. A desirable batwing light distribution pattern for indoor lighting is depicted in FIG. 5C. The wide distribution pattern may be utilized to increased spacing of light fixtures, which may lower the number of fixtures required in a given space. Due to the Inverse Square Law of light, the dip in light intensity in the 0-25 degree zones may effectively lower light levels directly beneath the light fixtures, creating an overall improvement in illumination uniformity on the work plane and may reduce veiling reflections.

Overall lamp hiding may also increase as intersection angle Φ associated with the LME 1 is increased. However, as the intersection angle Φ is decreased, the distance between lens members 3, 4 at the base of the V shape may also decrease, decreasing the distance between the light source 2 and the lens members 3, 4, which may decrease lamp hiding along lens members 3, 4 in the areas of close proximity to light source 2. In such an embodiment, the overall luminaire efficiency may decrease due to the increased light scattering and higher angle glare may also increase.

In certain example implementations, as the intersection angle Φ is increased, the effect on the lighting characteristics of example embodiments of LME 1 may reverse. For example, as the intersection angle Φ increases, the overall light scattering may decrease, which may narrow the relative light distribution. Light levels in the approximate 0-25 degree zones may be increase relative to the 25-60 degree zones. Overall lamp hiding may decrease, but lamp hiding in close proximity to the light source may increase. Higher angle glare may decrease and overall luminaire efficiency may increase.

Example embodiments of V-shaped LME's described herein may also have the advantage of a pleasing visual appeal. A typical application for example embodiments of the LME's described herein may include linear recessed light fixtures. By virtue of example embodiments comprising two elongated lens members with a center apex line, the overall form may be visually homogenous with linear fixtures.

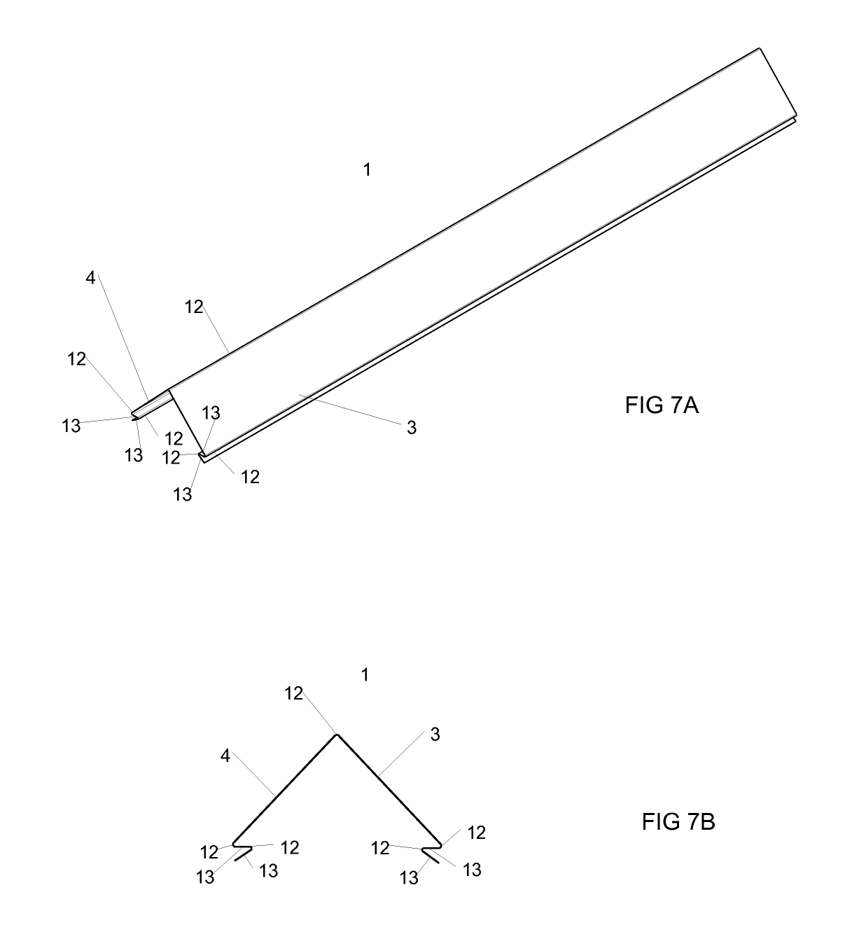

As recited in the “Related Applications” section, this application is a continuation-in-part of PCT Patent Application PCT/US2013/039895 entitled “Frameless Light Modifying Element” filed May 7, 2013. As described in the PCT/US2013/039895 PCT application, various example embodiments of self-supporting optical film lenses were included which incorporate “edge trusses” on two or more edges of an optical film piece, wherein the edges trusses are created by scoring and folding (or only folding as described) the optical film edges in various fashions. In example embodiments, edge trusses may impart sufficient structural rigidity to pieces of optical film to support portions of the optical film in a substantially planar configuration. FIG. 7A and FIG. 7B depicts an example implementation of the technology utilizing optical film in a manner similar to that described in the PCT/US2013/039895 PCT application. For example, FIG. 7A depicts a perspective view, and FIG. 7B depicts a side cross-sectional view.

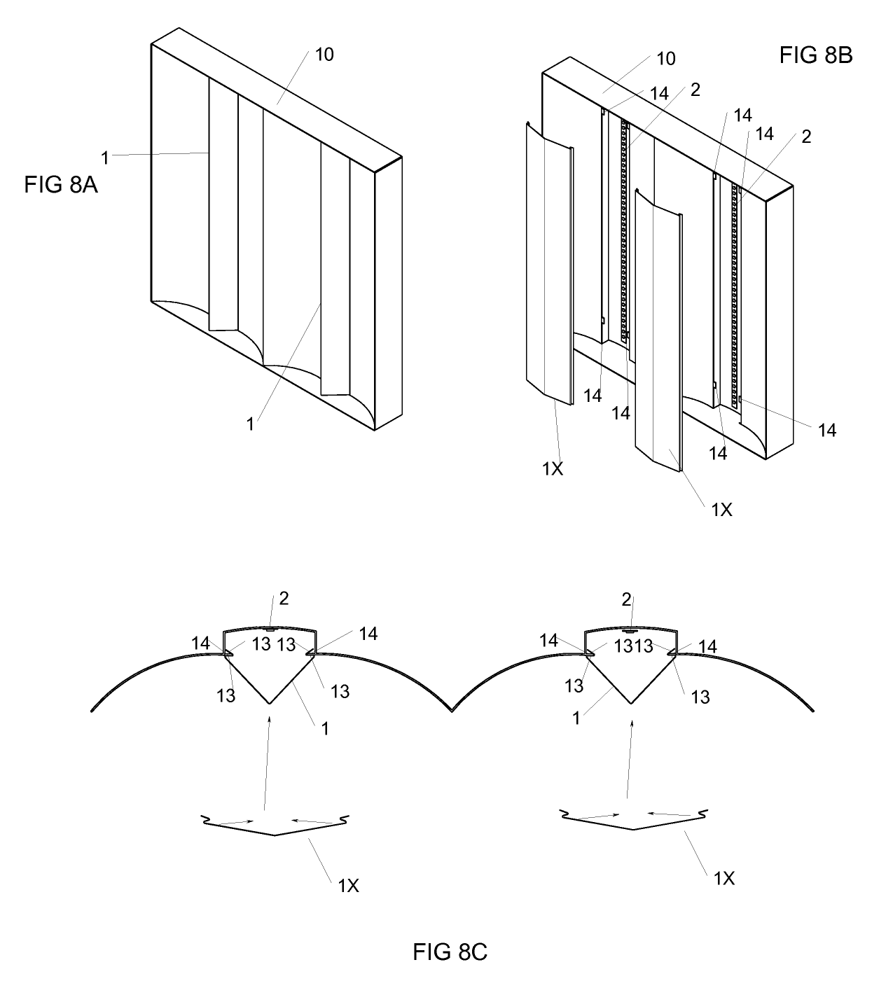

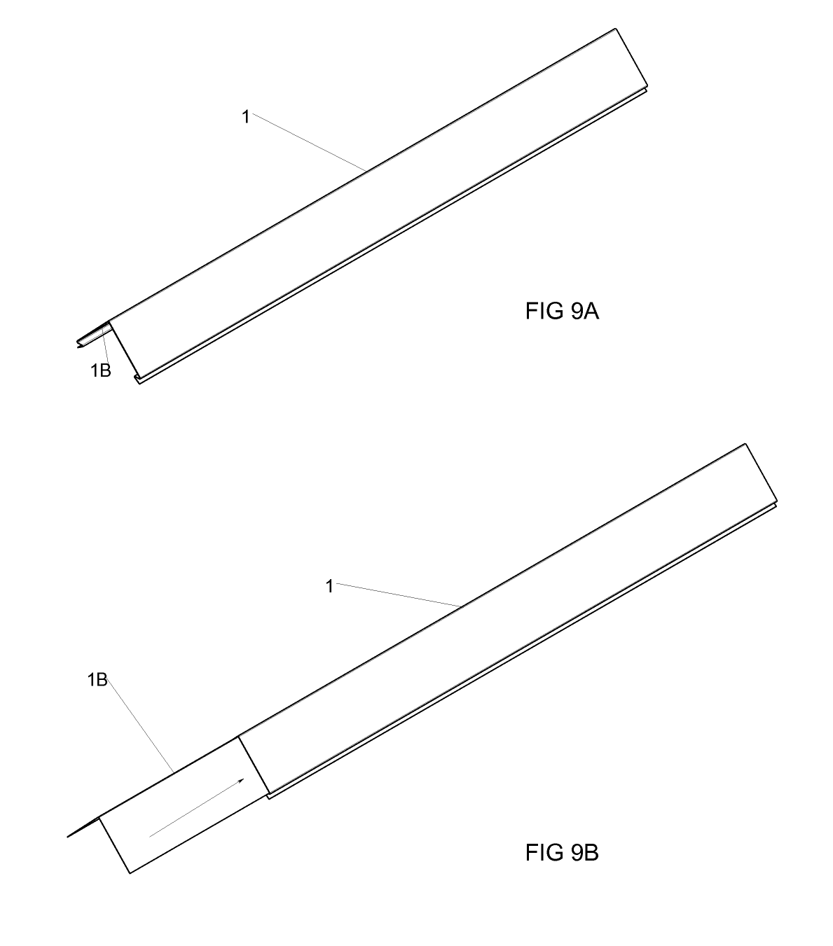

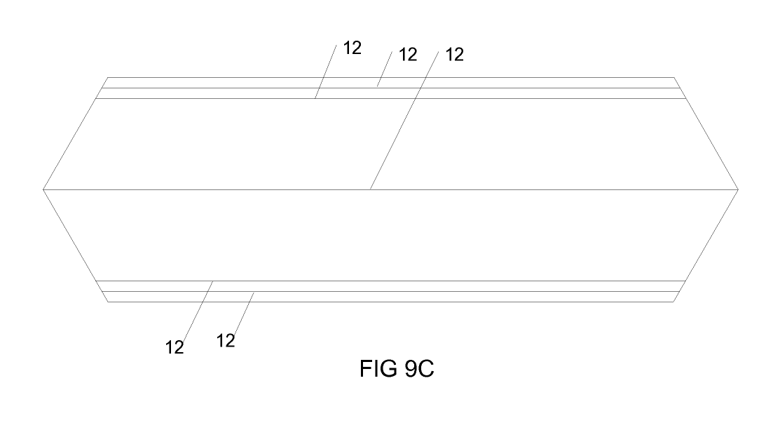

In certain example implementations, the LME 1 may comprise a single piece of optical film. The optical film may comprise any type of optical film that may be suitable for an intended application, and may include any types of optical film as described in the related applications, which may include diffusion films, diffusion films with light condensing properties, prismatic films, holographic films etc. According to an example implementation of the disclosed technology, the LME 1 may be configured with score lines 12 wherein the film may be folded along score lines 12, creating two edge trusses 13 on two opposing sides of the LME 1, and two lens members 3, 4 as previously described. In certain example embodiments, folds may be created along the same lines without scoring provided the means of folding can produce acceptably suitable folds. FIG. 9C depicts an example optical film cutting and scoring template for the example embodiment shown FIG. 7A and FIG. 7B. This example cutting template includes fold or score lines 12, along which the optical film may be subsequently folded. In accordance with an example implementation of the disclosed technology, a piece of optical film may be cut utilizing this template by methods previously described, and then folded in such a manner wherein the edge trusses 13 of the LME 1 are configured as shown in FIG. 7B. The lens members 3, 4 may be created by folding the film along the center score line 12. Once folded and creased along the center line, the two lens members may be unfolded and flattened wherein the two lens members may be disposed relatively parallel to each other, and may look similar to the LME 1X in FIG. 8B.

FIG. 8A shows a perspective view of a recessed light fixture 10 with an example embodiment of the LME 1 comprising optical film. FIG. 8B is an exploded perspective view of the same, which includes lens mounting tabs 14 on the light fixture 10, along with light sources 2. FIG. 8C shows a side cutaway view of a recessed light fixture 10 which includes mounting tabs 14 and light sources 2. In certain example implementations, the LME 1X may be similar to the example embodiments of LME 1 as shown in FIG. 7A, FIG. 7B, and FIG. 8A, but shown in their natural uncompressed state wherein the intersection angle between each lens member is relatively large. An example of an LME 1X is also shown in FIG. 8B. In this embodiment, the edges at the base of the LME 1X may be manually squeezed together in the direction of the horizontal arrows, wherein spring tension is imparted into each lens member. The LME 1X may be positioned and placed on a fixture 10 in the direction of the vertical arrows, and the V-shaped intersection of edge trusses 13 on each side of the LME 1 may be aligned on corresponding tabs 14 as shown in FIG. 8C. When the manual pressure is released, spring tension stored in the lens members of LME1 may hold the LME 1 securely in place on mounting tabs 14.

There may be many possible methods of attachment of example embodiments of the disclosed technology to any given light fixture, as well as LME dimensions and configurations which may vary depending on the light fixture configuration, the intended application etc. Although a particular method of attachment and general LME size and edge truss configuration has been described with respect to a particular light fixture, this should not in any way limit the general scope of example embodiments.

Example embodiments of the disclosed technology may be attached to light fixtures with magnets, hook and loop fasteners, adhesives, clips, extrusions, springs, or any other method which may be suitable for the application. Protuberances such as rivets, clips etc. may be installed on edge trusses of example embodiments wherein the protuberances may attach to corresponding areas of a light fixture, securing an example embodiment to a light fixture.

A particularly useful optical film for use in example embodiments intended for use in light fixtures may be diffusion films designed for use in displays such as televisions and monitors. These diffusion films may typically have a clear polyester base with a diffusion coating on the outer surface which may contain glass beads, such as the “Light Up” product line of diffusion films from Kimoto Tech. Diffusion films come in a wide variety of diffusion configurations, and some may have a degree of light condensing properties. When multiple layers of these films are combined together, the degree of light condensing may become multiplied, and because of this property, several layers of these films may be used in televisions and monitors to boost brightness and the illumination uniformity of the backlight. The light condensing characteristics of the diffusion films as described may be advantageous in example embodiments that may be subsequently disclosed.

FIG. 9A shows an example embodiment of the LME 1 similar to that shown and described in FIG. 7A and FIG. 7B, with the addition of inner layer 1B nesting inside the LME 1. For example, an inner layer 1B may comprise any type of optical film that may be suitable for an intended application. The Inner layer 1B may be sized slightly smaller than the LME 1, and may slide inside the LME 1 in the direction of the arrow in FIG. 9B. As many subsequent inner layers as needed for an intended application may be nested inside the LME 1, according to an example implementation of the disclosed technology.

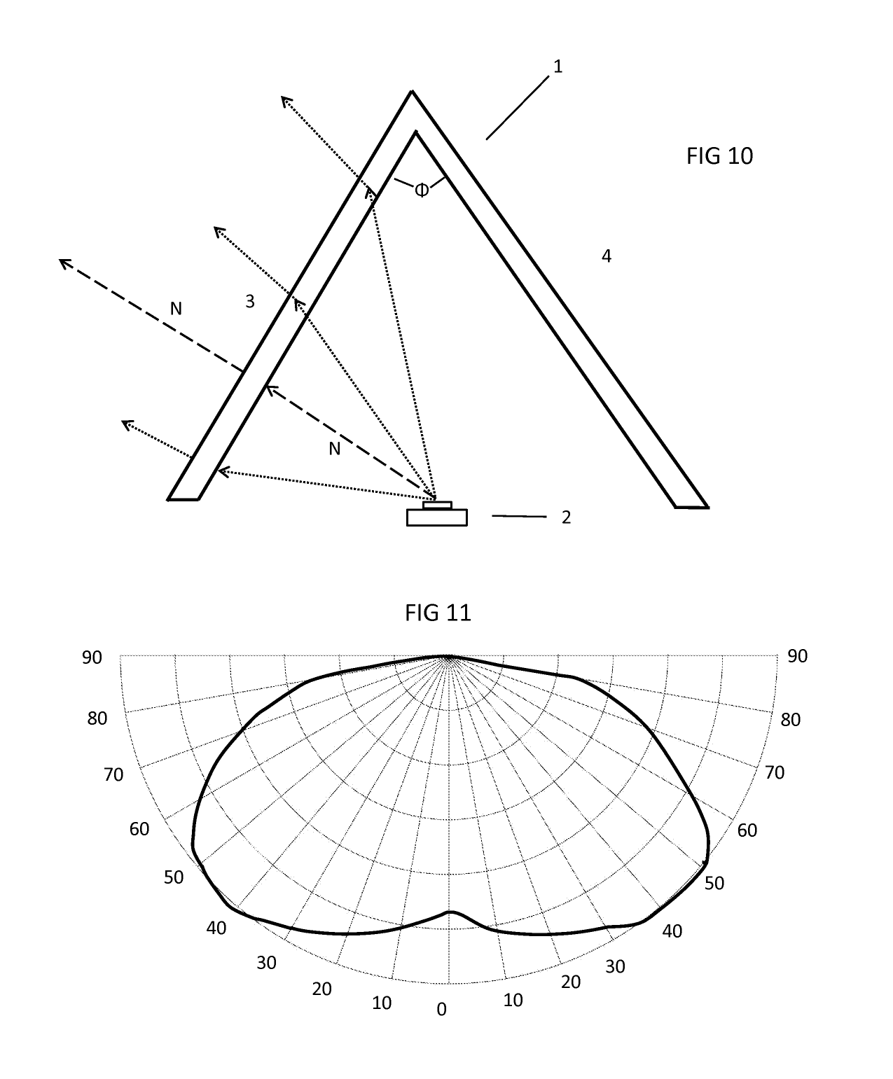

In certain example implementations, the LME 1 (with or without inner layer 1B) may be comprised of diffusion film with light condensing properties as previously described, or comprised of any kind of light condensing film, and in such embodiments, the lighting characteristics of the LME 1 may be altered. FIG. 10 shows an example embodiment of the LME 1 comprising light condensing film (not to scale), and light source 2 disposed inside the LME 1. Generally speaking, a flat light condensing optical film may direct a portion of light refracting through it more towards the direction of the normal of its surface. Example light rays from light source 2 are represented by the dotted arrows in FIG. 10. When incident light is refracted through light condensing lens member 3, it may be directed more towards the direction of surface normal N. Because of this, a greater portion of light from light source 2 may directed outwards towards the direction of normals N than would have otherwise if LME 1 was comprised of non-light condensing optical film. Accordingly, when mounted on a light fixture as shown in FIG. 8A, for example, less light may be directed in a forward direction than would be if the example embodiment of LME did not have light condensing properties. Thus, example embodiments utilizing condensing film (or other light condensing materials) may create an area of lower light intensity in the 0-25 degree zones, which may create a desirable batwing light distribution pattern similar to that shown in FIG. 11, and as previously described. As the degree of light condensing properties of the optical film utilized in example embodiments of LME increases, so may the exaggeration of the batwing distribution. Accordingly, the intersection angle Φ of members 3, 4 may be altered, along with the light condensing properties of the optical film utilized, in order to achieve to required light distribution pattern for a given application. Again, an acceptable amount of high angle light from example embodiments of LME may be shielded from direct view by the light fixture enclosure as previously described.

As disclosed, example embodiments of V-shaped LMEs utilizing traditional diffuser materials or optical films with traditional diffusion properties may enable light fixtures to have an advantageous wide angle light distribution with acceptably low high angle glare, while having an advantageously low manufacturing cost, which may be significantly lower than other more complex lens designs. Example embodiments of V-shaped LMEs utilizing materials or optical films with light condensing properties may enable an advantageous batwing light distribution with acceptably low high angle glare, while having a similarly advantageously low manufacturing cost which may be significantly lower than other lens designs providing a similar light distribution patterns.

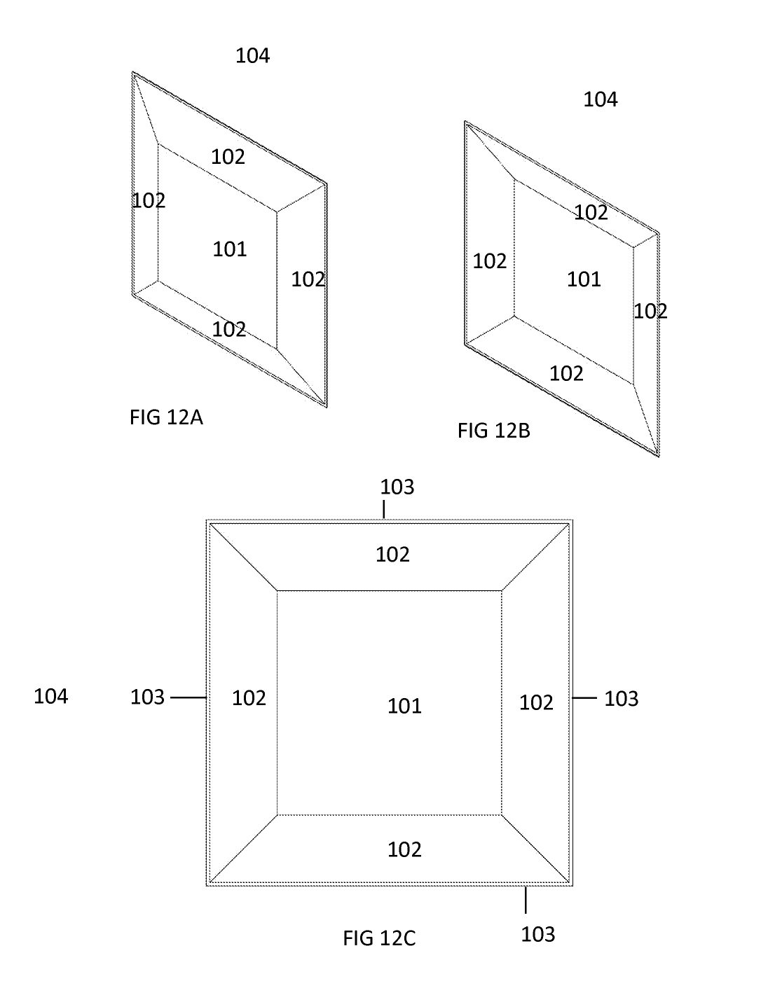

An example implementation of the disclosed technology is depicted in FIG. 12A, FIG. 12B, and FIG. 12C. For example, FIG. 12A depicts a rear perspective view, FIG. 12B depicts a front perspective view, and FIG. 12C depicts a front plan view of an example LME 104. In certain example implementations, the LME 104 may be used to modify light from a luminaire or any other suitable light source. In an example implementation, the LME 104 may comprise an inner face 101, sloped sides 102, and lips 103. Inner face 101 may be disposed on a plane parallel and adjacent to lips 103, and may comprise perimeter dimensions smaller than the innermost perimeter dimensions of lips 103. The shape of the LME may comprise a hollow truncated-pyramid.

In certain example implementations, the LME 104 may be fabricated from any suitable substrate such as acrylic or polycarbonate for example, and may be clear or translucent. In certain example implementations, the substrate may include light modifying elements such as diffusion material in the substrate itself as previously discussed. In other example implementations, diffusion material may be applied to one or more surfaces of the substrate. In certain example implementations, one or more surfaces of the substrate may include light modifying optical film overlays. In certain example implementations, one or more surfaces may include prismatic features such as those on prismatic acrylic lenses found on standard recessed linear luminaires. The scope of light modifying elements associated with the LME 104 need not be limited in any way. The LME 104 may be fabricated by any suitable and cost effective methods typically used in plastic part fabrication such as injection molding, vacuum forming etc.

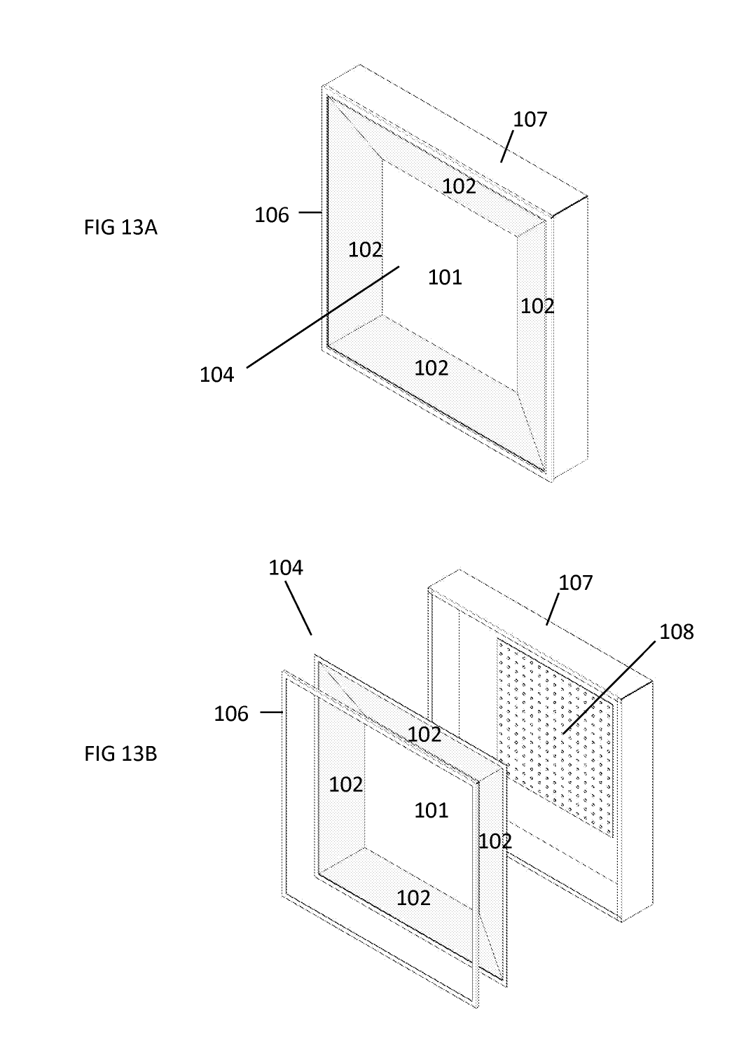

In certain example implementations, the LME 104 may be attached to a luminaire wherein lips 103 are disposed in proximity to the plane of the face of a luminaire, wherein the LME 104 may be oriented such that the inner face 101 may be disposed inside or outside the space defined by the luminaire enclosure. There may be advantages in having the LME 104 oriented such that the inner face 101 is disposed inside a luminaire. For example, and according to one implementation as shown in the perspective view of a luminaire 107 in FIG. 13A, the LME 104 may be mounted in a doorframe 106. FIG. 13B depicts an exploded view of same, which includes a light source 108, which may for example, be an LED array with a size similar to the inner face 101. In certain example implementations, the LME 104 with appropriate diffusion properties may be mounted in luminaire 107 as shown, and may include an inner face 107 which may be sized to the light source 108 and disposed parallel to light source 108, and the inner face 107 may be evenly illuminated by light source 108. By virtue of the hollow truncated-pyramid shape of the LME 104, sloped sides 102 may be disposed at corresponding angles to the light source 108 and partially shielded from direct light from the light source 108 by an inner face 101. Accordingly, the sloped sides 102 may be illuminated to a lesser degree than inner face 101, which may create a sharply defined and evenly illuminated “shadow box” effect around inner face 101. This shadow box effect may create an advantageously desirable visual appeal to the LME 104. For example, the LME 104 may include a flat lens mounted in doorframe 106, which may be typical of recessed luminaires, and the flat lens may be evenly illuminated directly above light source 108, but exhibit progressively lower illumination in the area between light source 108 and doorframe 106, creating an undefined shadow of varying intensity.

According to an example implementation of the disclosed technology, the lips 103 (as depicted in FIG. 12C) may function to facilitate mounting example embodiments of the technology in a luminaire or luminaire doorframe. Accordingly, example embodiments of the technology may be configured without lips 103 if this mounting feature is not required.

As shown in FIG. 13A, the inner face 101 may be regressed inside the luminaire 107. Accordingly, when the luminaire may be viewed from a distance at high viewing angles, the inner face 1 may be shielded from direct view, and the sloped sides 102, which are illuminated to a lesser degree than the inner face 101, may only be visible. This may reduce high angle glare which may be advantageous in many lighting applications.

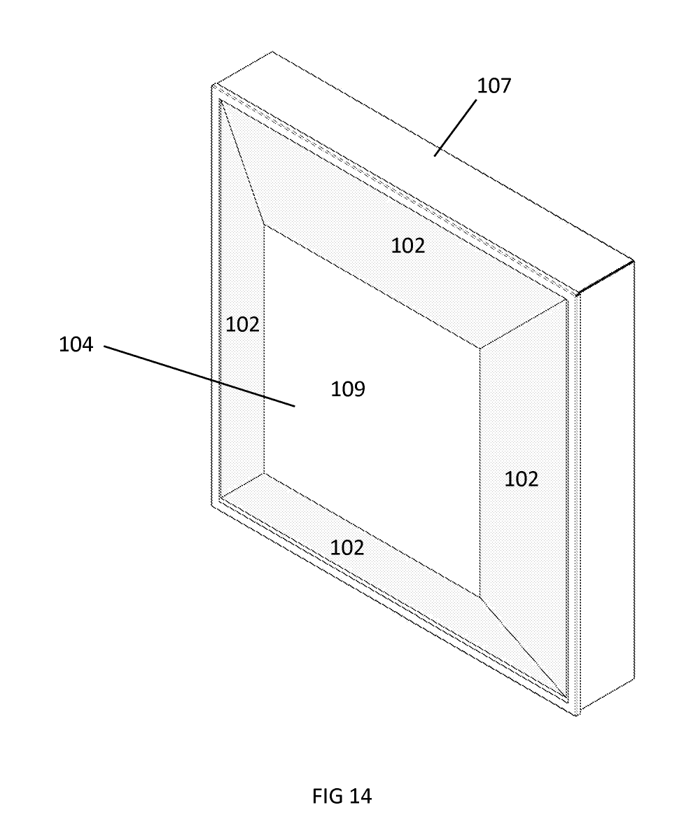

Referring now to FIG. 14, in an example implementation, the LME 104 may also be flipped 180 degrees relative to the plane of the face of luminaire 107 such that inner face 101 is disposed outside luminaire 107, and becomes an outer face 109. In such an orientation, sloped sides 102 may still be illuminated to a lesser degree than outer face 109, which may also create the desirable defined shadow box effect. This orientation of the LME 104 may have the advantage of outer face 109 having a greater distance to the light source 108, which may create greater diffusion and lamp hiding, and may allow the LME 104 to be configured with less diffusion, which may create greater luminaire efficiency.

In an example implementation of the technology, an LME may be fabricated from optical film in a similar fashion to optical film lenses described in PCT/US2013/039895, of which this current application is a continuation-in-part.

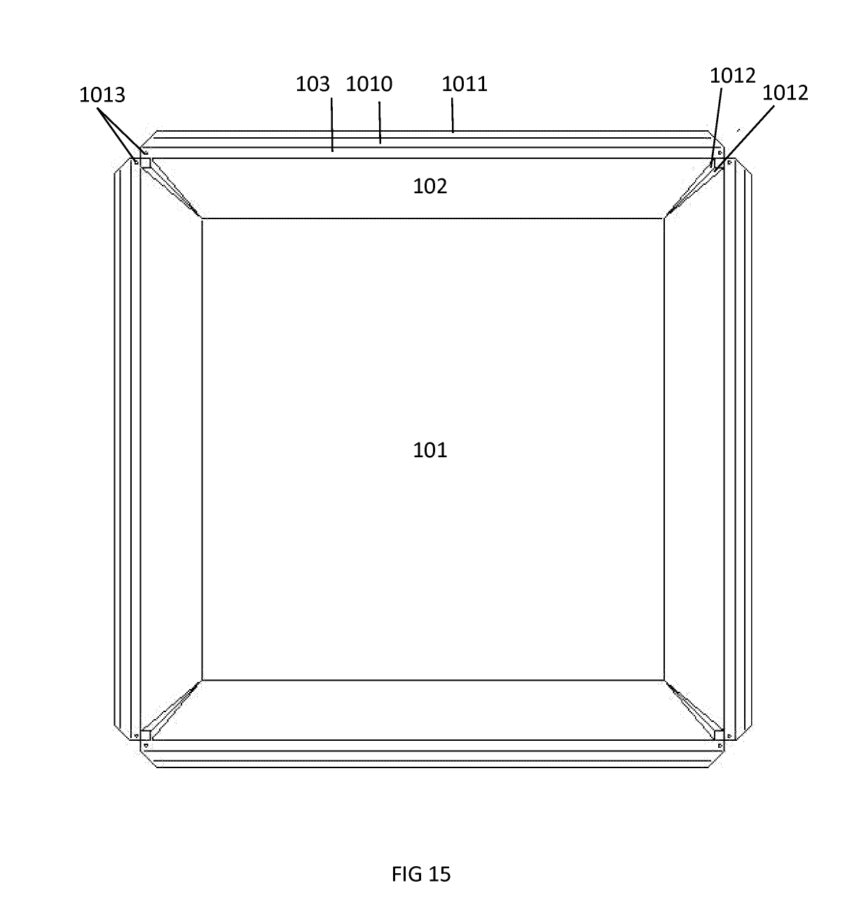

FIG. 15 depicts an optical film-cutting and scoring template for an example embodiment of the technology. The areas on the flat template may include one or more of: an inner face 101, sides 102, lips 103, edge trusses 1010, edge trusses 1011, and/or edge tabs 1012.

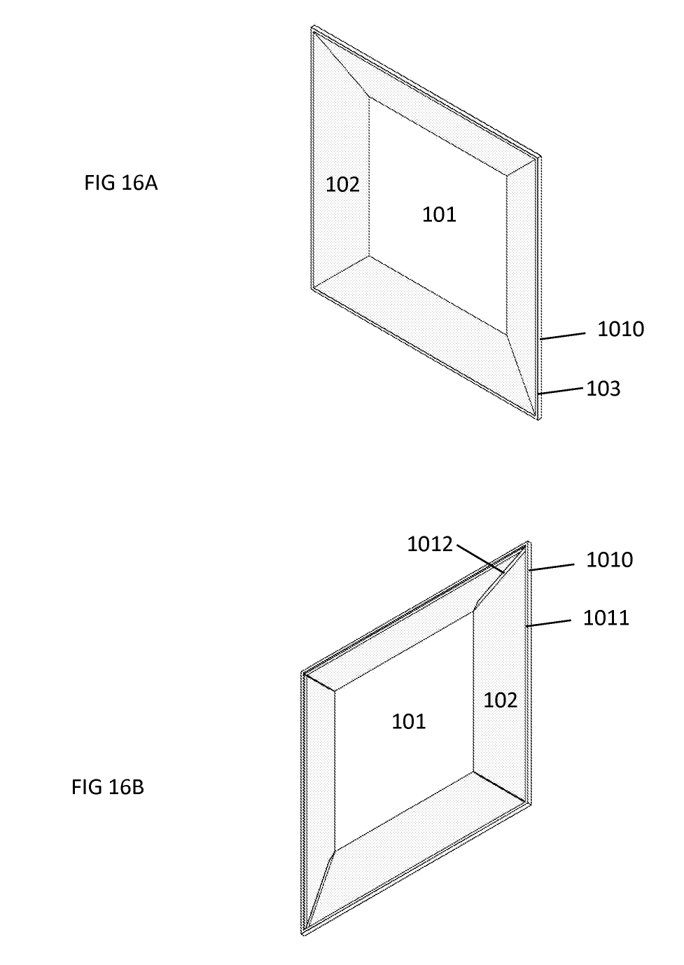

FIG. 16A shows a perspective front view of the assembled example embodiment of an LME as shown in FIG. 15 after the optical film sheet has been cut out and the lip sections 103, edge trusses 1010, 1011, and edge tabs 1012 have been appropriately folded along their score lines. In certain example implementations, the corners of lip 103 may be fastened together with plastic or metal rivets through holes 1013, as depicted in FIG. 15. The assembled example embodiment may be mounted in a luminaire doorframe. FIG. 16B shows a perspective rear view of the same example embodiment. When folded as shown, the edge tabs 1012 may function to hold the seams between each sloped side 102 tightly together, and may function to impart additional structural rigidity to the LME. In certain example implementations, the edge tabs 1012 may be glued together, sonically welded together, or joined in any other method that may be visually and structurally acceptable.

Although the previous example embodiment was shown as being configured to mount in a luminaire doorframe, certain example embodiments may be configured as a frameless LME as described in other example embodiments of this application or related applications, and mount directly to a luminaire without a doorframe. In certain example implementations, multiple layers of optical films may be utilized. In certain example implementations, each layer may nest inside an adjacent layer.

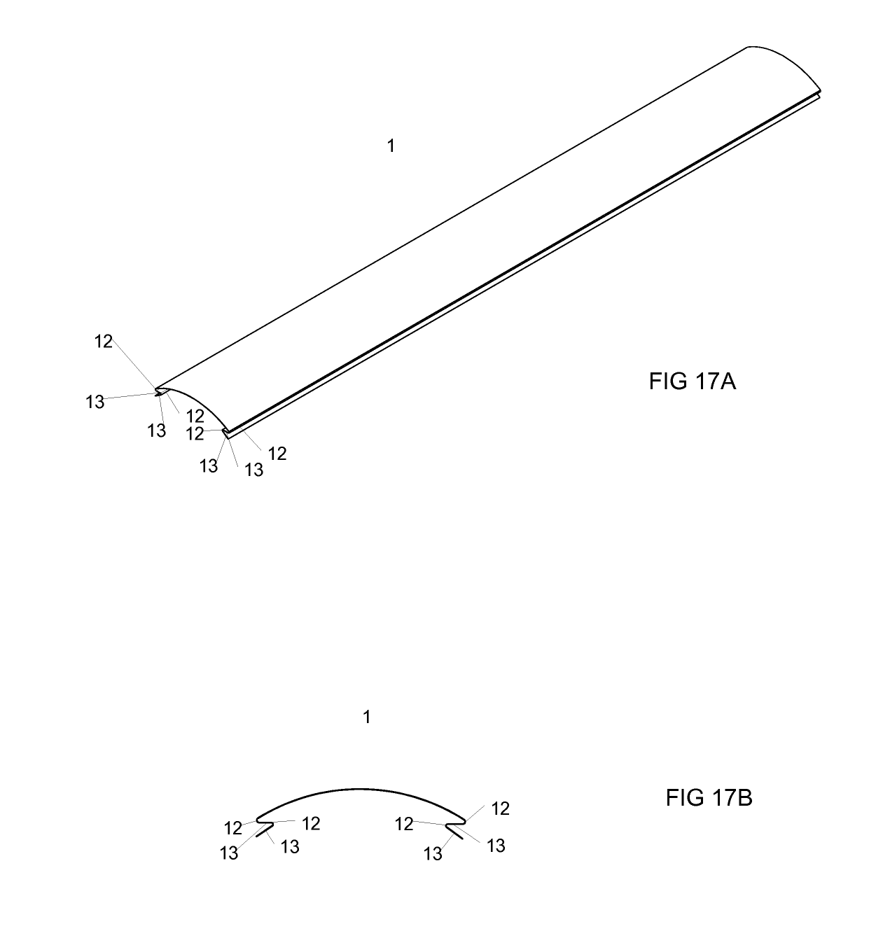

FIG. 17A and FIG. 17B depict an example implementation of the technology with a curved LME utilizing optical film in a manner similar to that described in the related application PCT/US2013/039895. FIG. 17A depicts a perspective view, and FIG. 17B depicts a side cross-sectional view. In one example implementation, the LME 1 may comprise a single piece of optical film. The optical film may include any type of optical film that may be suitable for an intended application, and may include any types of optical film as described in related applications, which may include diffusion films, prismatic films, holographic films etc. The LME 1 may be configured with score lines 12, wherein the film may be folded along score lines 12, creating two edge trusses 13 on two opposing sides of the LME 1.

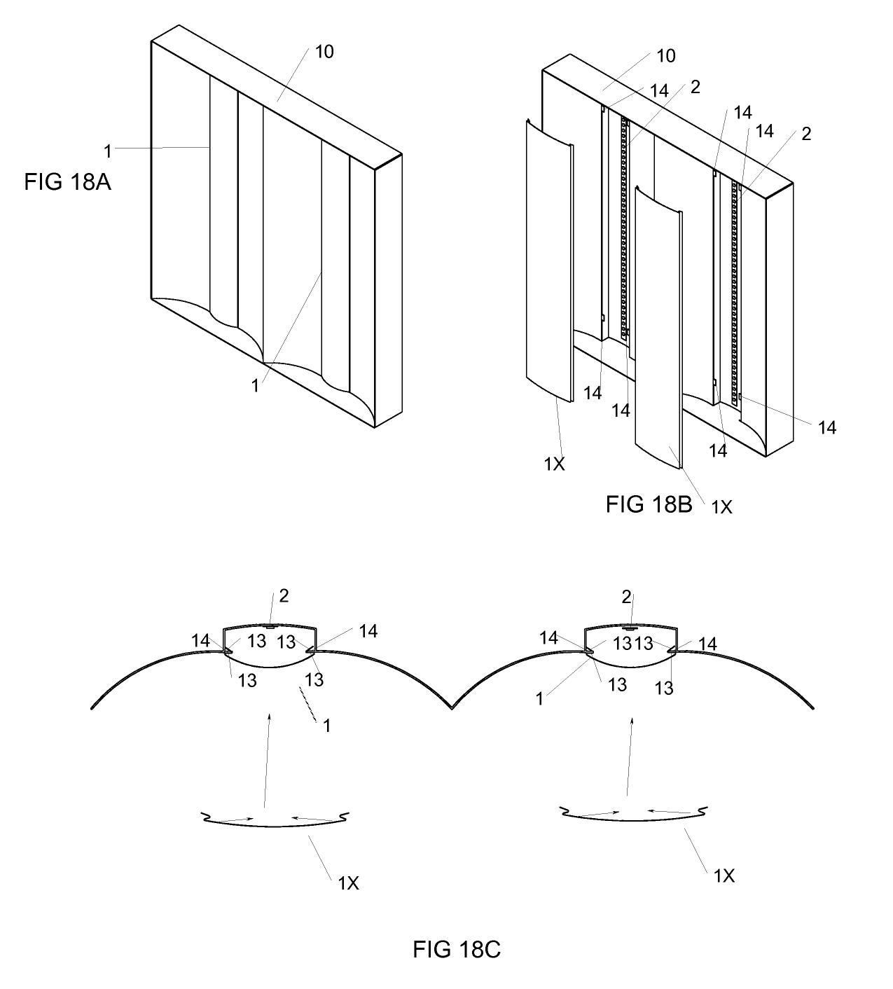

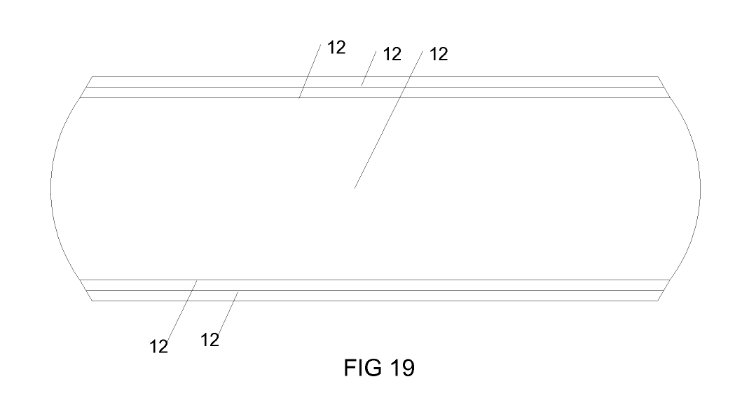

FIG. 19 shows the optical film cutting and scoring template for the example embodiment shown in FIG. 17B and FIG. 17B. This cutting template includes score lines 12, along which the optical film may be subsequently folded. A piece of optical may be cut utilizing this template by methods previously described, and then folded in such as fashion wherein the edge trusses 13 of the LME 1 are configured as shown in FIG. 18C.

FIG. 18A shows a perspective view of a recessed light fixture 10 with an example embodiment of curved the LME 1 comprising optical film. FIG. 8B shows an exploded perspective view of the same, which includes lens mounting tabs 14 on light fixture 10. FIG. 18C shows a side cutaway view of recessed light fixture 10 and includes mounting tabs 14. The LME 1X may be example embodiments of LME shown in FIG. 17A, 17B, and 18A, shown in their natural uncompressed state wherein the main LME surface may be flat or relatively flat. The LME 1X is also shown in FIG. 18B. Referring to FIG. 18C, the edges at the base of the LME 1X may be manually squeezed together in the direction of the horizontal arrows, wherein spring tension may be imparted into the optical film between the opposing edge trusses on each side of the LME 1, which may cause the LME 1 to form a curved shape. In certain example implementations, the LME 1X may be placed in position on fixture 10 in the direction of the vertical arrows, and the V-shaped intersection of edge trusses 13 on each side of the LME 1 may be aligned on corresponding tabs 14. When the manual pressure is released, spring tension stored in the lens members of LME1 may hold the LME 1 securely in place on mounting tabs 14.

There may be many possible methods of attachment of example curved embodiments of the disclosed technology to a given light fixture, as well as LME dimensions and configurations, which may vary depending on the light fixture configuration, intended applications etc. Although a particular method of attachment and general LME size and edge truss configurations have been described with respect to a particular light fixture, this should not in any way limit the general scope of example embodiments.

Example embodiments of LME may comprise two or more LME “sections” that are assembled, joined, or otherwise utilized together in an LME assembly, wherein each section comprises one or more optical film pieces.

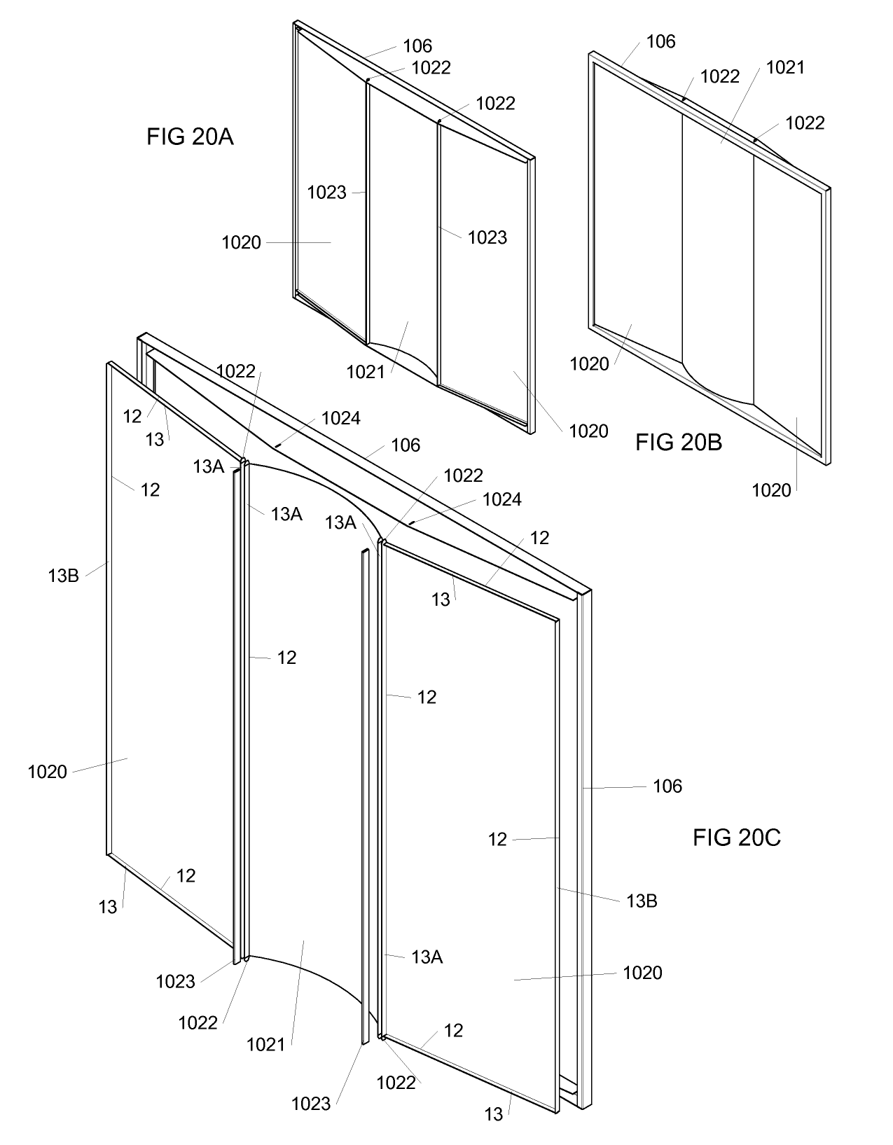

FIG. 20A shows a rear perspective view of an example embodiment of LME comprising a center section 1021, and two side sections 1020. FIG. 20B shows a front perspective view, and FIG. 20C shows a perspective exploded rear view.

Referring to FIG. 20C, side sections 1020 may comprise optical film pieces configured with edge trusses 13, 13A, and 13B created along fold lines 12. The inner-most edge truss 13A on each side panel 1020 may include tabs 1022 which may be configured with barbs, which may insert into slots 1024 on a light fixture doorframe 106. The opposing outer-most edge trusses 13B may be configured to lodge between, hook onto, or otherwise engage metal folds within the doorframe 106, wherein the outer-most edge trusses 13B may be suitably secured to the doorframe 106. In an example implementation, a center section 1021 may comprise a flat optical film piece which may be configured with two edge trusses 13A created along fold lines 12 as shown, along with barbed tabs 1022 which may be configured substantially the same as tabs 1022 on side sections 1020. On a flat surface with the edge trusses facing upwards, the center section 1021 may be positioned between both side sections 1020 (with the edge trusses of the side sections 1020 facing upwards) such that the inner-most edge trusses 13A of the side panels 1020 may mate with the corresponding edge trusses 13A on the center section 1021. The mated edge trusses may be joined together with a plastic extrusion 1023 (as shown in FIG. 20A and FIG. 20C). According to certain example implementations of the disclosed technology, the mated edge trusses may also be joined together in any suitable manner which may be cost effective and visually acceptable, such as sonic welding, adhesives, clips, rivets, etc.

After an example embodiment of LME is assembled as described, the LME assembly may be positioned and attached into a doorframe 106 as shown in FIG. 20A and FIG. 20B. In an example implementation, the edge trusses 13B (as shown in FIG. 20C) may be engaged into folds within the doorframe 106, and tabs 1022 may be inserted into slots 1024 on the doorframe 106. When inserted, the barbs may keep the tabs 1022 securely fastened in the slots 1024. According to an example implementation of the disclosed technology, the lateral force applied to center section 1021 in order to insert the tabs 1022 into the slots 1024 may cause the optical film piece to bend and form a curve as shown in FIG. 20B.

According to an example implementation of the disclosed technology, the center section 1021 and side sections 1020 may comprise any type of optical film that may be suitable for an intended application, and as with other example embodiments, additional optical film layers may nest together. The center section 1021 may comprise the same optical film type as the side sections 1020, or may comprise a different type. For example, if an example light fixture has a center mounted light source, the center section 1021 may comprise a heavier diffusion film than side sections 1020, which may improve luminaire efficiency compared to an example embodiment were all three sections comprised the same heavier diffusion film.

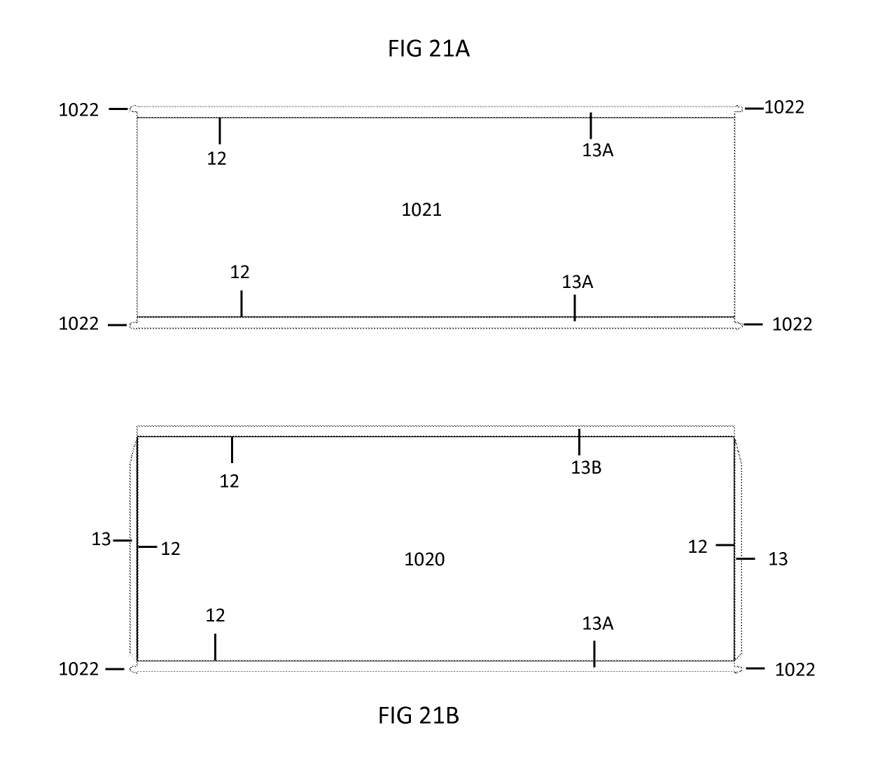

FIG. 21A shows a flat optical film cutting and scoring template for the center section 1021 (as shown in FIG. 20C), and indicates fold lines 12, edge sections 13A and barbed tabs 1022. Similarly, FIG. 21B shows a flat optical film cutting and scoring template for the side sections 1020 (as shown in FIG. 20C), and indicates fold lines 12, edge sections 13A and 13B and barbed tabs 1022.

The side panels 1020 (FIG. 20C) are shown with an edge truss on each side. However, in certain embodiments, edge trusses 13 may not be necessary if the thickness of the optical film utilized (and the distance the end panels 1020 are required to span) allow the end panels 1020 to be disposed in an acceptably planar configuration.

An example embodiment of LME has been described, which may comprise LME sections that are joined together in an LME assembly, wherein each section comprises one or more optical film pieces. This description is intended to illustrate in a general manner that individual optical film pieces configured according example implementations of the disclosed technology utilizing and one or more edge trusses on two or more sides of each optical film piece may be combined together to form a light modifying element assembly. Many other assembly configurations may be created using any combination of two or more sections.

Example embodiments of LME sections may comprise any shape that may be suitable for a particular assembly, which may include, but not be limited to v-shaped, square, concave or convex curves, flat, truncated pyramid, etc. In certain example implementations, sections may be joined or attached to each other. In certain example implementations, LME sections need not be joined or attached to each other, and may be configured to function in proximity to each other. For example, a light fixture or light fixture doorframe may have elements associated with them that may allow the two or more LME sections to attach directly to said elements, wherein the LME sections may be disposed adjacent to each other without being attached or joined to each other. In certain example implementations, a light fixture or light fixture doorframe may have structural elements such as sheet metal strips or beams for example, which may function as borders or dividers between two adjacent LME sections. In certain example implementations, LME section may or may not attach to said structural border or divider elements.

According to an implementation of the disclosed technology, a biplanar light modifying element may be configured to modify light from a light source wherein the light source is disposed in proximity to an inner portion of the biplanar light modifying element. The biplanar light modifying element may include one or more optical film pieces characterized by one or more edge trusses disposed at two or more opposing edges of at least one of the one or more optical film pieces. The one or more edge trusses may be characterized by one or more folds of at least a portion of at least one of the one or more optical film pieces. The one or more edge trusses disposed at two or more opposing edges may be further characterized to support the one or more edge trusses on the two or more opposing edges in a substantially planar configuration. The biplane light modifying element may be further configured with at least one fold in a central area of the one or more optical film pieces, wherein the one fold is substantially parallel to one or more edge trusses.

According to an example embodiment of the biplanar light modifying element, one or more optical film pieces are further configured for suspension or attachment by at least a portion of two opposing edge trusses.

According to an example embodiment of the biplanar light modifying element, one or more optical film pieces can be further characterized by one or more fold lines comprising one or more of score lines, crimp lines or perforated lines, and wherein at least a portion of the one or more folds disposed at two or more opposing edges and the central area of the one or more optical film pieces are made along one or more fold lines.

According to an example embodiment of the biplanar light modifying element, one or more optical film pieces can be further configured for attaching to a light emitting device.

According to an example embodiment of the biplanar light modifying element, one or more optical film pieces can be further characterized by nested optical film pieces.

According to an example embodiment of the biplanar light modifying element, the light modifying element can include or utilize magnets, protrusions, hook and loop fasteners, adhesives, clips, extrusions or springs configured to attach the light modifying element to a light emitting device.

According to an example embodiment of the biplanar light modifying element, the light modifying element can be further configured with edge trusses on two opposing sides of the one or more optical film pieces that are configured to attach to mounting protrusions on a light fixture.

According to an example embodiment of the biplanar light modifying element, the light modifying element can be further characterized by one or more of light diffusion properties or light condensing properties.

According to an implementation of the disclosed technology, a biplanar light modifying element can be configured to modify light from a light source located in proximity to an inner portion of the biplanar light modifying element. The biplanar light modifying element may comprise at least two planar lens members configured in an elongated V-shape. The at least two planar lens members are characterized by an optical material that includes one or more of:
a) embedded diffusion particles configured to scatter the light from the light source, and/or
b) at least one surface characterized by a plurality of surface features arranged in a random distribution pattern and configured to scatter light from the light source.

According to an example embodiment of biplanar light modifying element, the light modifying element can be configured to attach to a light fixture.

According to an example embodiment of biplanar light modifying element, a light modifying element is provided wherein at least two planar lens members can include a rigid or semi rigid substrate.

According to an example embodiment of biplanar light modifying element, a light modifying element is provided wherein at least two planar lens members can further be characterized by one or more of light diffusion properties or light condensing properties.

According to an implementation of the disclosed technology, a curved light modifying element can be configured to modify light from a light source located in proximity to an inner portion of the curved light modifying element. The curved light modifying element can include one or more optical film pieces characterized by a central light emitting portion and one or more edge trusses disposed at two opposing edges of at least one of the one or more optical film pieces. The one or more edge trusses can include one or more folds of at least a portion of at least one of the one or more optical film pieces. The one or more edge trusses disposed at two opposing edges can support the two opposing edges of the one or more optical films in a substantially planar configuration. The central light emitting portion can be formed into a curved shape by laterally moving the two opposing edges of the one or more optical films towards each other.

According to an example embodiment of curved light modifying element, one or more optical film pieces can further be configured for suspension or attachment by at least a portion of two opposing edge trusses.

According to example embodiment of curved light modifying element, one or more optical film pieces can include one or more fold lines comprising one or more of score lines, crimp lines, or perforated lines. In an example implementation, the one or more folds disposed at the two opposing edges of the one or more optical film pieces can be made along one or more fold lines.

According to an example embodiment of curved light modifying element, one or more optical film pieces can further be configured for attaching to a light emitting device.

According to an example embodiment of curved light modifying element, one or more optical film pieces can be characterized by nested optical film pieces.

According to an example embodiment of curved light modifying element, one or more optical film pieces can be further utilize and/or include magnets, protrusions, hook and loop fasteners, adhesives, clips, extrusions or springs configured to attach the light modifying element to a light emitting device.

According to an example embodiment of curved light modifying element, one or more optical film pieces can be configured with two or more edge trusses on two opposing sides of the one or more optical film pieces, wherein the two or more edge trusses on the two opposing sides can be configured to attach to mounting protrusions on a light fixture.

According to an example embodiment of curved light modifying element, one or more optical film pieces can be further characterized by one or more of light diffusion properties or light condensing properties.

According to an implementation of the disclosed technology, a light modifying element is provided which comprises one or more optical film pieces characterized by one or more edge trusses disposed on each edge of at least one of the one or more optical film pieces. The one or more edge trusses can be characterized by one or more folds of at least a portion of at least one of the one or more optical film pieces. Edge trusses disposed at each edge can be further characterized to support the one or more optical film pieces in a substantially planar configuration. The one or more optical film pieces can be further configured to form a hollow truncated pyramid shape characterized by four sloping sides, a planar base and a planar top wherein the plane of the planar top is substantially parallel to the plane of the planar base, and wherein the perimeter of the planar top is smaller than the perimeter of the planar base.

According to an example embodiment of the truncated pyramid shaped light modifying element, one or more optical film pieces can be configured for suspension by at least two edge trusses or by at least a portion of two perimeter surfaces associated with at least one of the one or more optical film pieces.

According to an example embodiment of truncated pyramid shaped light modifying element, one or more optical film pieces can be further characterized by one or more fold lines comprising one or more of score lines, crimp lines or perforated lines, and wherein at least a portion of the one or more folds disposed at each edge of the one or more optical film pieces can be made along one or more fold lines.

According to an example embodiment of truncated pyramid shaped light modifying element, the light modifying element can be further configured for attaching to a light emitting device.

According to an example embodiment of truncated pyramid shaped light modifying element, the light modifying element can be configured to mount substantially inside a light fixture enclosure, or outside a light fixture enclosure.

According to an implementation of the disclosed technology, an assembly of light modifying elements can be configured to modify light from a light source, and may include two or more light modifying element sections. Each section can be characterized by one or more optical film pieces, wherein one or more edge trusses can be configured on two or more opposing sides of at least one of the one or more optical film pieces. The one or more edge trusses can be characterized by one or more folds of at least a portion of at least one of the one or more optical film pieces. The one or more edge trusses can be further characterized to support at least two or more edges of the one or more optical film pieces in a substantially planar configuration.

According to an example embodiment of an assembly of light modifying elements, the assembly of light modifying elements can be configured to attach to a light emitting device.

According to an example embodiment of an assembly of light modifying elements, the assembly of light modifying elements can be configured to attach to a doorframe of a light emitting device.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A biplanar light modifying element configured to modify light from a light source located in proximity to an inner portion of the biplanar light modifying element, the biplanar light modifying element comprising:
a least two planar lens members configured in an elongated V-shape, the at least two planar lens members are characterized by an optical material that includes one or more of:
embedded diffusion particles configured to scatter the light from the light source; and
at least one surface characterized by a plurality of surface features arranged in a random distribution pattern and configured to scatter light from the light source.

2. The biplanar light modifying element of claim 1, further comprising:
one or more optical film pieces characterized by:
one or more edge trusses disposed at two or more opposing edges of at least one of the one or more optical film pieces, the one or more edge trusses characterized by one or more folds of at least a portion of at least one of the one or more optical film pieces, the one or more edge trusses disposed at two or more opposing edges are further characterized to support two or more opposing edges of the at least one of the one or more optical film pieces in a substantially planar configuration; and
at least one fold in a central area of the one or more optical film pieces, wherein the one fold is substantially parallel to one or more edge trusses.

3. The biplanar light modifying element of claim 2, wherein the one or more optical film pieces are further configured for suspension or attachment by at least a portion of two or more edge trusses.

4. The biplanar light modifying element of claim 2, wherein the one or more optical film pieces are further characterized by one or more fold lines comprising one or more of score lines, crimp lines or perforated lines, and wherein at least a portion of the one or more folds disposed at the two or more opposing edges and the central area of the one or more optical film pieces are made along one or more fold lines.

5. The biplanar light modifying element of claim 2, wherein the one or more optical film pieces are further characterized by nested optical film pieces.

6. The biplanar light modifying element of claim 2, wherein the one or more optical film pieces are further characterized by one or more of magnets, protrusions, hook and loop fasteners, adhesives, clips, extrusions, and springs configured to attach the light modifying element to a light emitting device.

7. The biplanar light modifying element of claim 2, wherein the edge trusses on two opposing sides of the one or more optical film pieces are configured to attach to mounting protrusions on a light fixture.

8. The biplanar light modifying element of claim 1, wherein the at least two planar lens members comprise a rigid or semi rigid substrate.

9. A curved light modifying element configured to modify light from a light source located in proximity to an inner portion of the curved light modifying element, the curved light modifying element comprising:
one or more optical film pieces characterized by:
a central light emitting portion; and
one or more edge trusses disposed at two opposing edges of at least one of the one or more optical film pieces, the one or more edge trusses characterized by one or more folds of at least a portion of at least one of the one or more optical film pieces, the one or more edge trusses disposed at the two opposing edges are further characterized to support the two opposing edges of the at least one of the one or more optical film pieces in a substantially planar configuration; and
wherein the central light emitting portion is configured into a curved shape by laterally moving the two opposing edges of at least one of the one or more optical film pieces towards each other.

10. The curved light modifying element of claim 9, wherein the one or more optical film pieces are further configured for suspension or attachment by at least a portion of the one or more edge trusses disposed at the two opposing edges of at least one of the one or more optical film pieces.

11. The curved light modifying element of claim 9, wherein the one or more optical film pieces are further characterized by one or more fold lines comprising one or more of score lines, crimp lines or perforated lines, and wherein at least a portion of the one or more folds disposed at the two opposing edges of the one or more optical film pieces are made along the one or more fold lines.

12. The curved light modifying element of claim 9, wherein the one or more optical film pieces are further characterized by nested optical film pieces.

13. The curved light modifying element of claim 9, further comprising one or more of magnets, protrusions, hook and loop fasteners, adhesives, clips, extrusions, and springs configured to attach the light modifying element to a light emitting device.

14. The curved light modifying element of claim 9, wherein the two or more edge trusses on the two opposing sides are configured to attach to mounting protrusions on a light fixture.

15. A light modifying element comprising:
one or more optical film pieces characterized by:
one or more edge trusses disposed on each edge of at least one of the one or more optical film pieces, the one or more edge trusses characterized by one or more folds of at least a portion of at least one of the one or more optical film pieces, the one or more edge trusses disposed at each edge are further characterized to support the one or more optical film pieces in a substantially planar configuration; and
the one or more optical film pieces are further configured to form a hollow truncated pyramid shape characterized by four sloping sides, a planar base and a planar top, wherein the plane of the planar top is substantially parallel to the plane of the planar base, and wherein the perimeter of the planar top is smaller than the perimeter of the planar base.

16. The light modifying element of claim 15, wherein the one or more optical film pieces are further configured for suspension by at least two edge trusses or by at least a portion of a two perimeter surfaces associated with at least one of the one or more optical film pieces.

17. The light modifying element of claim 15, wherein the one or more optical film pieces are further characterized by one or more fold lines comprising one or more of score lines, crimp lines or perforated lines, and wherein at least a portion of the one or more folds disposed at each edge of the one or more optical film pieces are made along one or more fold lines.

18. The hollow truncated pyramid shaped light modifying element of claim 15, further configured to mount substantially inside a light fixture enclosure, or outside a light fixture enclosure.

19. An assembly of light modifying elements configured to modify light from a light source, comprising:
two or more light modifying element sections, wherein each section is characterized by:
one or more optical film pieces, wherein one or more edge trusses are configured on two or more opposing sides of at least one of the one or more optical film pieces, the one or more edge trusses characterized by one or more folds of at least a portion of at least one of the one or more optical film pieces, the one or more edge trusses are further characterized to support at least two or more edges of the one or more optical film pieces in a substantially planar configuration.

20. The assembly of light modifying elements of claim 19, wherein the assembly is configured to attach to a light emitting device.

21. The assembly of light modifying elements of claim 19, wherein the assembly is configured to attach to a doorframe of a light emitting device.
